(19) United States
(12) Patent Application Publication
(10) Pub. No.: US 2023/0015918 A1
(43) Pub. Date: Jan. 19, 2023

(54) ARTIFICIAL INTELLIGENCE PHOTOGRAPH RECOGNITION AND EDITING SYSTEM AND METHOD

(71) Applicant: EarthCam Inc., Upper Saddle River, NJ (US)

(72) Inventors: Juan NAVAS, Fair Lawn, NJ (US); Brian CURY, Alpine, NJ (US)

(21) Appl. No.: 17/855,046

(22) Filed: Jun. 30, 2022

Related U.S. Application Data
(60) Provisional application No. 63/216,781, filed on Jun. 30, 2021.

(51) Int. Cl. G06T 7/00; G06V 10/24; G06V 10/44; G06V 10/60; G06V 10/74; G06V 10/764; G06V 10/82

(52) U.S. Cl. CPC G06T 7/0002; G06V 10/245; G06V 10/44; G06V 10/60; G06V 10/761; G06V 10/765; G06V 10/82; G06T 2207/10016; G06T 2207/30168

(57) ABSTRACT

A system and method for reviewing and editing a series of time lapse photographs, using a machine learning system to review sequentially the individual photographs in the series, identify features in the photographs which features may have been classified as undesirable and flag an individual photograph as undesirable, remove photographs flagged as undesirable from the series set, review the remaining images from the series set of photographs for lighting and composition characteristics and further selection, process the selected photographs for image stabilization, and assembling the processed photographs into a single video for viewing.

### CROSS REFERENCE TO RELATED APPLICATIONS

The present application claims priority to the provisional patent application assigned No. 63/216,781, filed on Jun. 30, 2021 and bearing the same title as set forth above; that provisional application is incorporated herein in its entirety.

### FIELD OF INVENTION

The invention is in the field of image editing, specifically creating videos from still photographs.

### BACKGROUND OF THE INVENTION

It is well known to set up cameras to take photographs at set intervals, resulting in a series of time-lapsed photographs. It is also known that videos may be created by assembling a series of these photographs. Where a camera may be in place for an extended period of time, there may be little difference between one photograph to the next photograph in the series. Composing videos with substantially identical photographs often results in long videos with lengthy stretches of apparent static views. Where a video is intended to show change or transition, static views are not desired.

Another concern is the presence of external elements that may interfere with a particular photograph, such as rain, snow, fog, or transient debris. Heavy precipitation may obscure a camera lens, or even leave water droplets on the lens that obscure the captured image. Creating a video from photographs containing obstructed views is not desirable.

Currently, people are often employed to review large numbers of photographs and remove undesired photographs before selecting a set of photographs for composition of a video. This requires many man-hours of time to be spent reviewing thousands of photographs to produce a single video that excludes undesired images.

It is desired to provide an automated method for reviewing and selecting photographs from a large set of photographs, to produce a time lapse video without undesired images.

### SUMMARY OF THE INVENTION

The invention is a system and method for taking a series of time lapse photographs, using a machine learning system to review sequentially the individual photographs in the series, identify features in the photographs that may have been classified as undesirable and flag individual photographs as undesirable, remove photographs flagged as undesirable from the series, review the remaining images from the series for lighting and composition characteristics and further selection, process the selected photographs for image stabilization, and assembling the processed photographs into a single video for viewing.

### BRIEF DESCRIPTION OF THE DRAWINGS

FIGS. 1 to 3 are flow chart diagrams showing a preferred embodiment of the system.

FIG. 4 is a computer for use in practicing the present invention.

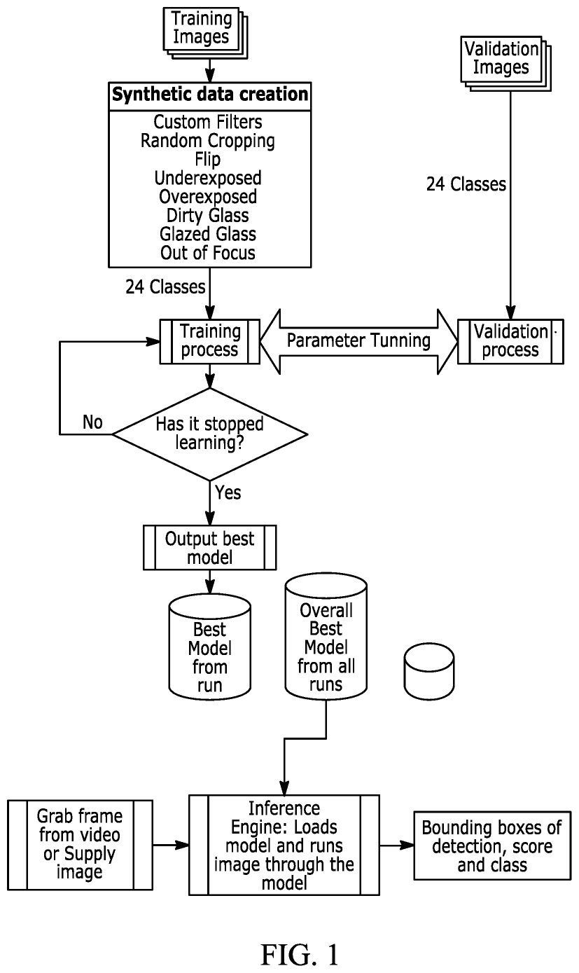

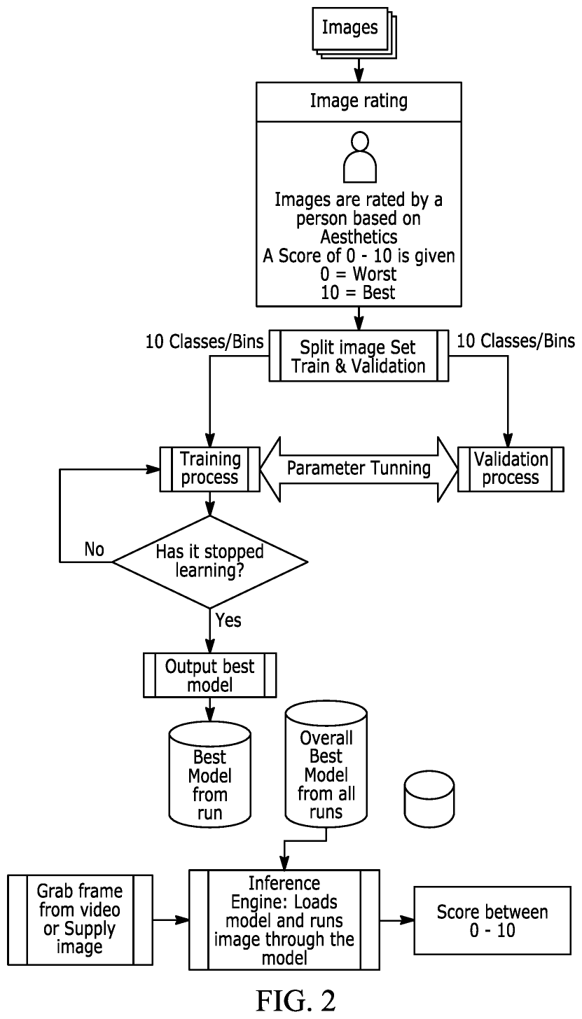

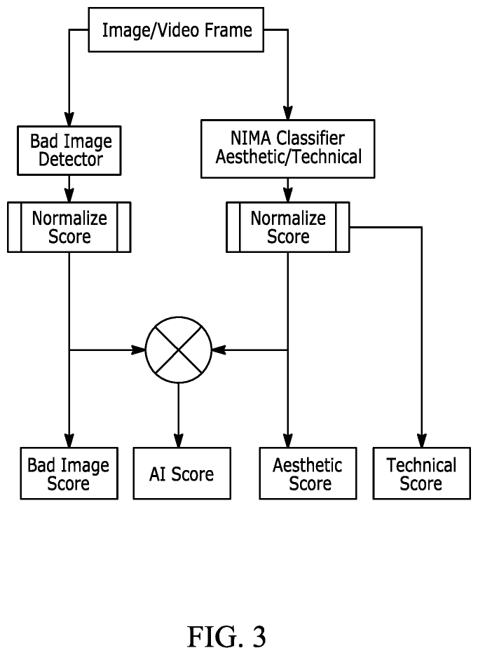

### DETAILED DESCRIPTION

The invention preferably consists of creating enhanced videos from time-lapse still photographs, by removing undesired image frames and ensuring image stabilization.

The main objective of the inventive process is to produce high quality time-lapse videos without human interaction. In order to achieve this objective, the inventors have developed a set of processes that follow the same rules that human video editors follow. An initial selection process starts with a set of photographs originating from a camera at a predetermined location and orientation, such as a camera located at a construction site. The set of photographs then is then input to an artificial intelligence (AI) engine that assigns a rating to each photograph. This rating is based on features in the photographs that the AI system has been trained to detect.

The AI process was trained to detect features in a photograph based on input from video editors. For example, video editors discard photographs that show severe weather conditions. The AI machine learning algorithm was trained with photographic data sets showing examples of severe weather conditions and taught to reject such photographs.

In addition to recognizing photographs that show adverse weather conditions, the AI system has been trained to detect certain features that could be considered desirable or undesirable, such as photographs in which objects obscure a large region of the photographic scene.

As a first selection step, the AI system reviews each photograph from a set of time lapse photographs, identifies whether each photograph includes a characteristic that matches a set of undesirable characteristics, and selects the photograph for inclusion in a first subset of photographs or flags the photograph as undesirable.

AI Process:

For the AI system to process the photographs for desirable and/or undesirable features, the system must first be trained to recognize these features.

The core of the process is the neural network that has been trained with the inventor's photographs. To train the neural network the inventors gathered thousands of photographs that had features similar to those they liked and disliked in time-lapse videos. Within each photograph they marked and labeled features that they liked or disliked, to provide annotations with positive and negative characteristics. After all the photographs had been annotated, the annotated photographs were provided to a program written in Python that extracts the labeled features from the original photographs and creates an image of each individual labeled feature. Another Python program takes this collection of labels and runs it through the neural network.

The training process operates in the following steps. First, a label is chosen at random and the program is told to find it in a test photograph. The test photograph has already been labeled, and the label will be used by the learning process for scoring its finding. If the program finds the label within the test photograph, the program then activates a neuron within the neural network by adjusting weights based on the input. If the label is not found or the program labels something incorrectly, then the program does the opposite: it deactivates a neuron by adjusting the weights. This process is repeated millions of times until the inventors were satisfied the correct weights had been generated to active the neuron for that particular label.

The recognition process takes the neural network graph generated by the training process and uses it to predict the labels in the photographs in the set of photographs from the time lapse series. This recognition program first resizes the input image and split the input image into multiple sub-images. These smaller sub-images are run through the neural network, which then determines if any of the sub-images activate any of the neurons for the trained labels. If a neuron is activated it means that the sub-image, and the overall image, exhibits features that fits a pattern of a label. A probability score is generated for the sub-image with respect to the specific label, and the sub-image gets returned to the calling function. This process is repeated for each sub-image of a given image.

While at the present time, he inventors have trained the AI system to detect sixteen such features, the list of features to detect is not fixed and is expected to grow in the future.

In a similar manner, photographs that are found to contain features/labels that are not desired will generate a deactivated neuron. Photographs with a number of deactivated neurons above a baseline threshold will be not be included in the first subset of photographs.

Examples of undesirable features include, but are not limited to, the following: water droplets, fog, darkness, out of focus images, low light, light sources aimed at the camera lens, objects or artifacts (dirt) on the camera lens, and obstructions between the camera lens and the subject of the image.

After the AI system has rated all sub-images of each image, those images which have scored above a threshold level are retained in a first subset of photographs, with the remaining photographs being excluded from that subset for either not having high enough scores, or having enough undesirable features to be scored low for exclusion.

Following the image selection step, the first subset of photographs is then processed by a grading step. The selected photographs run through a system that grades the photographs on lighting conditions and other desirable features, and selects only desirable photographs as a second subset for the next process step, image stabilization.

The grading step is another trained AI process, using similar training from a control set of photographs with different labels for training purposes.

Examples of the desirable features include, but are not limited to, the following: clear images, focused images, well-lit images, and images where the lighting source is not in the camera field of view.

In the image stabilization step, the system reviews each photograph of the second subset, extracts trackable features from each photograph and compares them with the set of trackable features from the next photograph and/or previous photograph. After some computation is done and the trackable features between two photographs are matched, the pair of adjacent photographs in the subset are aligned.

By alignment, the inventors mean that the trackable features of the adjacent photographs appear in substantially the same locations in the field of view, such that in a transition between the two photographs, a viewer would not see the field of view shift, and fixed objects in the image would be in the same place.

After all the photographs are aligned, the photographs is sent to the rendering process which adds overlays, metadata and encodes the frames into a video, as is known in the art.

While certain novel features of the present invention have been shown and described, it will be understood that various omissions, substitutions and changes in the forms and details of the device illustrated and in its operation can be made by those skilled in the art without departing from the spirit of the invention.

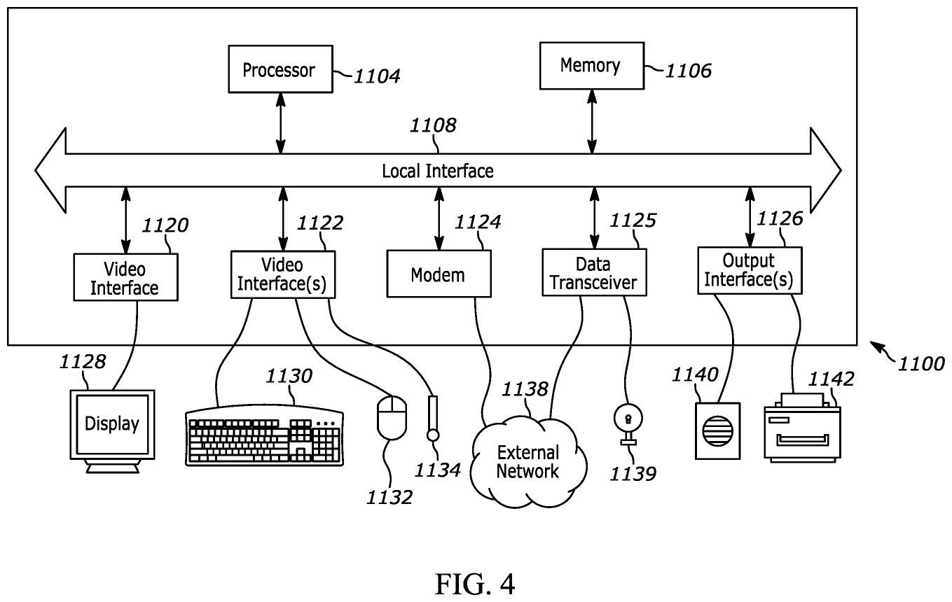

FIG. 4 illustrates a computer system 1100 for use in practicing the invention. The system 1100 can include multiple remotely-located computers and/or processors and/or servers (not shown). The computer system 1100 comprises one or more processors 1104 for executing instructions in the form of computer code to carry out a specified logic routine that implements the teachings of the present invention. The computer system 1100 further comprises a memory 1106 for storing data, software, logic routine instructions, computer programs, files, operating system instructions, and the like, as is well known in the art. The memory 1106 can comprise several devices, for example, volatile and non-volatile memory components further comprising a random-access memory RAM, a read only memory ROM, hard disks, floppy disks, compact disks including, but not limited to, CD-ROM, DVD-ROM, and CD-RW, tapes, flash drives, cloud storage, and/or other memory components. The system 1100 further comprises associated drives and players for these memory types.

In a multiple computer embodiment, the processor 1104 comprises multiple processors on one or more computer systems linked locally or remotely. According to one embodiment, various tasks associated with the present invention may be segregated so that different tasks can be executed by different computers/processors/servers located locally or remotely relative to each other.

The processor 1104 and the memory 1106 are coupled to a local interface 1108. The local interface 1108 comprises, for example, a data bus with an accompanying control bus, or a network between a processor and/or processors and/or memory or memories. In various embodiments, the computer system 1100 further comprises a video interface 1120, one or more input interfaces 1122, a modem 1124 and/or a data transceiver interface device 1125. The computer system 1100 further comprises an output interface 1126. The system 1100 further comprises a display 1128. The graphical user interface referred to above may be presented on the display 1128. The system 1100 may further comprise several input devices (some which are not shown) including, but not limited to, a keyboard 1130, a mouse 1131, a microphone 1132, a digital camera, smart phone, a wearable device, and a scanner (the latter two not shown). The data transceiver 1125 interfaces with a hard disk drive 1139 where software programs, including software instructions for implementing the present invention are stored.

The modem 1124 and/or data receiver 1125 can be coupled to an external network 1138 enabling the computer system 1100 to send and receive data signals, voice signals, video signals and the like via the external network 1138 as is well known in the art. The system 1100 also comprises output devices coupled to the output interface 1126, such as an audio speaker 1140, a printer 1142, and the like.

This Detailed Description is not to be taken or considered in a limiting sense, and the appended claims, as well as the full range of equivalent embodiments to which such claims are entitled define the scope of various embodiments. This disclosure is intended to cover any and all adaptations, variations, or various embodiments. Combinations of presented embodiments, and other embodiments not specifically described herein by the descriptions, examples, or appended claims, may be apparent to those of skill in the art upon reviewing the above description and are considered part of the current invention.

We claim:

1. A system for composing a video from a plurality of time-lapse photographs, the system comprising:
a neural network processing the plurality of time-lapse photographs, the neural network following the steps of:
reviewing each of the plurality of time-lapse photographs to identify whether a given photograph comprises a first characteristic;
comparing the first characteristic with a database of known characteristics, where each known characteristic is associated in the database with at least one evaluation flag, and if a match is made between the first characteristic and a known characteristic, retrieving an evaluation flag;
determining whether to retain or delete the given photograph based on the evaluation flag, and if the given photograph is to be retained, storing the given photograph into a first temporary file;
repeating the above steps until all of the plurality of time-lapse photographs have been reviewed;
reviewing the first temporary file of time-lapse photographs to evaluate each photograph based on lighting conditions present therein;
determining whether each photograph meets a predetermined lighting criteria, and if so, storing the photographs that meet such lighting criteria in a second temporary file;
reviewing the photographs in the second temporary file in sequence, identifying alignment features in each photograph and comparing the alignment features between two adjacent photographs in the sequence;
where alignment features between two adjacent photographs do not match, perform an image stabilization adjustment to one or both of the two adjacent photographs to put the alignment features into conformity; and
save the adjusted photographs into a third temporary file.

2. The system of claim 1, wherein the trained neural network includes at least one of a deep learning network or a neural network.

3. A method for composing a video from a plurality of time-lapse photographs, the method comprising the steps of:
obtaining a first set of rules that define desired characteristics of photographs as a function of visual elements of a photograph;
obtaining a plurality of time-lapse photographs;
generating a first intermediate stream of time-lapse photographs and a plurality of rejected photographs by evaluating said plurality of time-lapse photographs against said first set of rules; and
generating a second intermediate stream of time-lapse photographs by evaluating transition parameters between adjacent photographs in the first intermediate stream.

4. An artificial intelligence (AI) platform for detecting and evaluating image artifacts and image characteristics in a series of photographs, comprising:
a trained classifier that includes a deep learning model trained to detect image artifacts and image characteristics in image data; and
a real time video analysis system that receives the series of photographs, uses the trained classifier to determine if a single photograph from the series of photographs contains an image artifact, calculates the quality of the image artifact, and outputs an indication that the image artifact was detected and the nature and quality of the image artifact;
wherein the single photograph is flagged for removal from the series of photographs based on the nature of the image artifact and the calculated quality of the image artifact.

5. A photograph evaluation method comprising:
recognizing an image artifact in an photograph;
obtaining specification information of the image artifact and artifact quality information of the image artifact based on the specification information of the image artifact;
obtaining image value information of the photograph based on the specification information of the image artifact and artifact quality information of the image artifact; and
providing the image value information of the photograph.
